(19) United States
(12) Patent Application Publication
(10) Pub. No.: US 2023/0422352 A1
(43) Pub. Date: Dec. 28, 2023

(54) METHOD FOR MANUFACTURING A HEATING DEVICE, AND HEATING DEVICE

(71) Applicant: E.G.O. Elektro-Geraetebau GmbH, Oberderdingen (DE)

(72) Inventors: Wolfgang Thimm, Karlsruhe (DE); Patrick Kilian, Pforzheim (DE); Michael Tafferner, Malsch (DE)

(21) Appl. No.: 18/339,378

(22) Filed: Jun. 22, 2023

(30) Foreign Application Priority Data
Jun. 24, 2022 (DE) 10 2022 206 363.5

(51) Int. Cl. H05B 3/10; C25D 11/04; C23C 28/04

(52) U.S. Cl. CPC H05B 3/10; C25D 11/04; C23C 28/042

(57) ABSTRACT

A method for manufacturing a heating device having a carrier and at least one heating conductor applied thereto has the steps: provision of a carrier having a heating conductor side, wherein the carrier consists of aluminum, generation of an anodized layer on the heating conductor side, wherein the anodized layer is applied directly to the carrier and/or its heating conductor side, application of the at least one heating conductor above the anodized layer in a thick-film method. Advantageously, the anodized layer can be manufactured as a hard anodized layer. An additional insulation layer and/or a thickening layer can also be applied to the anodized layer.

### CROSS-REFERENCE TO RELATED APPLICATIONS

This application claims priority to German Application No. 10 2022 206 363.5, filed Jun. 24, 2022, the contents of which are hereby incorporated herein in its entirety by reference.

### AREA OF APPLICATION AND PRIOR ART

The invention relates to a method for manufacturing a heating device and to a heating device manufactured by such a method.

A heating device having a metallic carrier and several heating conductors applied thereto is known from EP 3197241 A1. The metallic carrier must be electrically insulated prior to application of the heating conductor. To do so, a thick-film paste containing glass is applied by means of a screen printing method. It is then stoved, to form a finished insulating layer. The heating conductors can then be applied to this insulating layer.

It is regarded as disadvantageous that the carrier has to withstand such high temperatures, which are necessary both for application of the insulating layer and for a possibly similar thick-film method.

### OBJECT AND SOLUTION

The object underlying the invention is to provide a method as stated at the outset and a heating device manufactured with such a method, using which problems of the prior art can be solved and enabling in particular provision of a readily usable and easy to manufacture heating device that permits safe operation.

This object is solved by a method having the features of claim 1 and by a heating device having the features of claim 14. Advantageous and preferred embodiments of the invention are the subject matter of further claims and are explained in greater detail in the following. Some of the features are described only for the method or only for the heating device manufactured therewith. They are however intended to apply by themselves and independently of one another, both for such a method and for such a heating device. The wording of the claims is based on express reference to the content of the description.

It is provided that the heating device has a carrier in the form of a metallic carrier, and at least one heating conductor applied to the carrier. This carrier is therefore provided in such a way that it has a heating conductor side. Furthermore, the material selected for the carrier is aluminum, which is readily and inexpensively available and has very good thermal conductivity properties for a heating device in particular. An anodized layer is generated on the heating conductor side, directly on the carrier and/or on its heating conductor side. This means that there is no further layer provided in between, i.e. between the carrier and/or its heating conductor side on the one hand and the anodized layer on the other. The anodized layer is advantageously applied galvanically, as is explained in more detail in the following. In an advantageous embodiment of the invention, a galvanic method can be used for generating and applying the anodized layer to the carrier and/or to its heating conductor side. To do so, the carrier is moved with at least its heating conductor side into a galvanic bath having an acid electrolyte. This acid electrolyte can have a relatively low temperature, preferably less than 20° C. Such a method is known for example from DE 10 2008 008 998 A1, to which explicit reference is made in this connection. Thanks to the relatively low temperature, the growth of the anodized layer can be controlled and an anodized layer of particularly high quality can be generated.

After that, the at least one heating conductor is applied above the anodized layer, either in a coating method, possibly directly to the anodized layer, or as a separate component or element. A thin-film method may be advantageously selected for this, but a thick-film method is particularly advantageous. Depending on the method selected, the heating conductor has a corresponding thickness, this being 20 μm to 200 μm in the case of a thick-film heating conductor. As an alternative to a heating conductor applied using a coating method, a metallic heating conductor may also be provided, advantageously with additional electrical insulation between the carrier and/or anodized layer on the one hand and the heating conductor on the other.

In an advantageous development of the invention, an additional insulation layer may be applied to the anodized layer in order to further improve the electrical insulation against the metallic carrier. An additional insulation layer of this type may in one embodiment be applied directly to the anodized layer as a thin layer, advantageously generated or applied by thermal spraying. It is here advantageously applied as an aluminum oxide layer. A possible method for doing so is known from DE 10 2008 026 101 A1, to which explicit reference is made in this connection.

In a possible development of the invention, the anodized layer may even be generated as a hard anodized layer, for which higher current densities are used. A temperature of the galvanic bath can again be considerably less than 20° C., advantageously between 0° C. and 15° C. A current density is preferably selected higher than when generating a normal anodized layer, advantageously with a current density of greater than 20 mA/cm2 or even greater than 30 mA/cm2. Such current densities can attain up to 60 mA/cm2 or 80 mA/cm2. A duration can be for example 30 mins to 60 mins. Sulfuric acid can be used as the acid electrolyte, so the galvanic bath can be an aqueous sulfuric acid bath. The sulfuric acid can be in a concentration of 15% by weight or 20% by weight. A hard anodized layer of this type is even harder and more stable than an aforementioned anodized layer on its own, regardless of which method was used to apply it.

An anodized layer can be applied with a thickness between 20 μm and 150 μm, preferably with a thickness between 40 μm and 100 μm. A thickness of the anodized layer can advantageously be around 100 μm. This allows a dielectric strength sufficient for a high-voltage test to be achieved.

The carrier preferably consists of an aluminum alloy which is relatively pure. Advantageously, an A199.5 or AlMg3 alloy may be used.

The heating conductor side may, as is known from anodizing methods or hard anodizing methods, be treated by mechanical machining, such as grinding, sandblasting or the like prior to generation of the anodized layer thereon. The adhesive properties of the anodized layer can then be improved.

In an advantageous development of the invention, a thickening layer may be applied as a further layer to the finished anodized layer or to an aforementioned additional insulation layer on the anodized layer. It is also possible to apply first a thickening layer to the anodized layer and an additional insulation layer to that. The thickening layer is preferably a high-temperature-resistant thickening layer which also withstands, without any damage, operation of the heating device per se as well as application and if applicable stoving of the heating conductor. A sol-gel sealant, a glass sealant or an aluminum phosphate sealant for example is ideal as the thickening layer. It can advantageously strengthen the electrical insulation of the anodized layer and at the same time seal it to achieve an even better resistance to environmental effects such as corrosion, acid, salt water or the like. Furthermore, the thickening layer can prevent the heating conductor being applied to a surface containing aluminum. It may therefore be necessary to meet minor requirements relating to the buildup or application of the heating conductor in a said coating method, in particular in a thick-film method.

A said thickening layer can have a lower thickness than the anodized layer itself. A thickness can be in a range between 10 μm and 100 μm. It can consist of aluminum oxide or of titanium dioxide; alternatively it can consist of chromium oxide, zirconium oxide or magnesium oxide.

A further advantage of the relatively lower temperatures during application of the different layers is a reduced warping of the material of the carrier that may be caused by different expansion coefficients of the various materials. This is very advantageous precisely because aluminum is not particularly hard.

As a general principle, heating conductors for several heating devices can also be applied to one carrier, i.e. as a multiple unit, in this invention. After application of the layers or after machining, the carrier can then be separated into several parts for the several individual heating devices. A standard separation is achieved by means of a laser. It may be advantageous to mask the separation points beforehand so that no aluminum oxide layer and/or anodized layer, thickening layer or additional insulation layer at all is present there, or at least not a thick layer. This makes the aforementioned separation easier.

A heating device in accordance with the invention is preferably installed in a pump for a water-carrying household appliance, advantageously a washing machine or a dishwasher, or a pump of that type has a heating device in accordance with the invention. Alternatively, a heating device in accordance with the invention can be fitted into an evaporator and/or steam generator for a cooking appliance, for example for an oven or steam cooker or into an aforementioned water-carrying household appliance.

These and further features are found in the description and in the drawings as well as in the claims, where the individual features can each be realized singly or severally in the form of sub-combinations in one embodiment of the invention and in other fields, and can represent designs advantageous and protectable per se, for which protection is claimed here. The subdivision of the application into individual sections and sub-headings does not limit the statements made thereunder in their general validity.

### BRIEF DESCRIPTION OF THE DRAWINGS

Examples of the invention are shown schematically in the drawings and are explained in more detail in the following. The drawings show in:

FIG. 1 a plan view onto a heating device in accordance with the invention with an anodized layer on a carrier of aluminum, to which a heating conductor is applied,

FIG. 2 a sectional view through a heating device similar to FIG. 1, showing the anodized layer on top of the carrier and an additional thickening layer between the anodized layer and the heating conductor,

FIG. 3 a schematic view of a method for manufacturing the anodized layer in a galvanic bath,

FIG. 4 a schematic view of a method for application of an additional insulation layer to the anodized layer by thermal spraying and

FIG. 5 a further possible method step with application of a thickening layer to the anodized layer or the additional insulation layer by means of a spraying device.

### DETAILED DESCRIPTION OF THE EXAMPLES

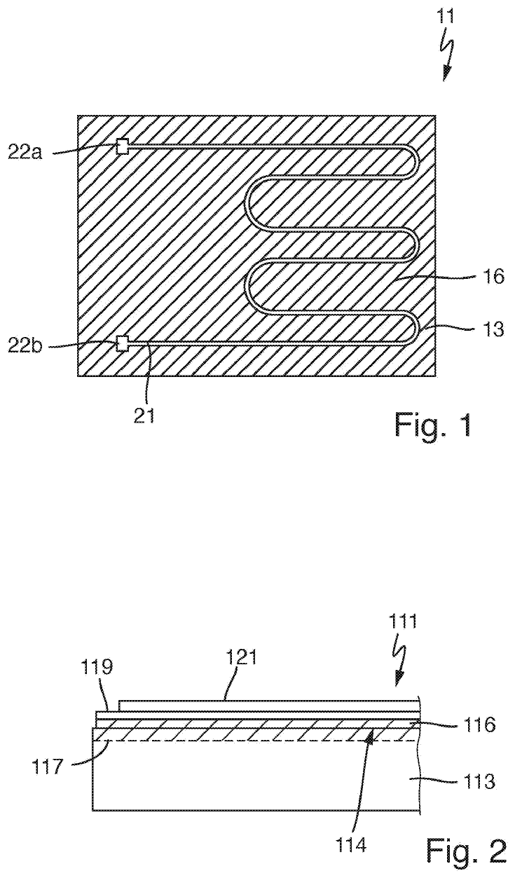

FIG. 1 shows a plan view onto a heating device 11 in accordance with the invention. The heating device 11 has a carrier 13, advantageously consisting of a pure or ultrapure aluminum alloy, for example Al99.5 or AlMg3. The carrier 13 is flat and rectangular, but may also have any other shape.

An anodized layer 16 shown hatched is applied to the carrier 13 and/or its upward-facing heating conductor side over the full surface. It insulates the carrier 13 and/or its heating conductor side in the same way as an electrical insulation layer. A heating conductor 21 can then be applied directly to this anodized layer 16, advantageously as a thick-film heating conductor using a standard method, in particular a screen printing method. The heating conductor 21 has a meandering form and can be electrically connected by means of two contact fields 22a and 22b in known manner. This corresponds of course to the known prior art. The anodized layer 16 thus provides sufficient electrical insulation between the heating conductor 21 and the contact fields 22a and 22b on the one hand and the metallic carrier 13 on the other. The anodized layer can also have a thickness as stated at the outset, for example around 50 μm.

FIG. 2 shows a sectional view through a somewhat modified heating device 111. Here too a flat carrier 113 made from an aforementioned aluminum alloy is provided, for example with a thickness of 0.5 mm to 5 mm. An anodized layer 116 is generated on an upward-facing heating conductor side 114 of the carrier 113 as electrical insulation. This anodized layer 116 however not only builds up on the heating conductor side and/or upper side of the carrier 113, but also effectively penetrates into this upper side with a penetration depth 117, shown hatched. This can be several micrometers thick and be up to half the thickness of the anodized layer 116. The anodized layer 116 consists in known manner of aluminum oxide, and during its growth the aluminum on the upper side and/or heating conductor side 114 is converted into aluminum oxide and hence into the anodized layer 116 itself.

A thickening layer 119 as explained at the outset is applied to the anodized layer 116. This is advantageously a sol-gel layer which is also high-temperature-resistant like the anodized layer 116 itself. It can be generated in the aforementioned manner, and can consist for example of a mixture of aluminum oxide and titanium dioxide, or alternatively of chromium oxide, zirconium oxide or magnesium oxide. Its thickness can be lower than that of the anodized layer 116, for example only half as thick, i.e. around 50 μm.

A heating conductor 121 is in turn applied as previously described to the thickening layer 119, advantageously once again by means of a screen printing method as a thick-film heating conductor.

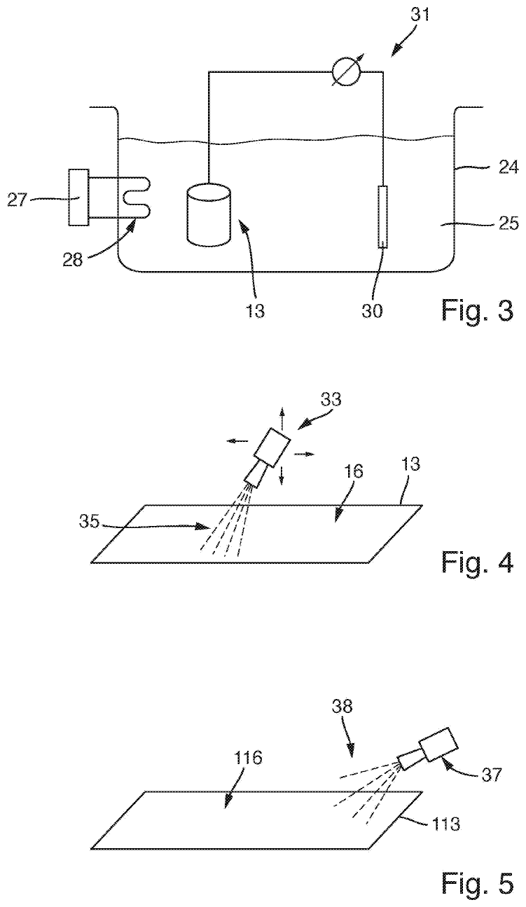

FIG. 3 shows how an anodized layer in accordance with the invention can be applied to a tubular carrier 213. To do so, the tubular carrier 213 is completely immersed in a container 24 with a galvanic bath 25 therein, advantageously of aqueous sulfuric acid. The galvanic bath 25 can be kept at an advantageously low temperature, for example at 5° C. constant, by means of a cooling device 27 having cooling coils 28. A voltage source 31 is connected on one side to an electrode 30 in the galvanic bath 25 and on the other side to the carrier 213 in electrically conductive manner. It can thus be achieved by applying such a voltage that a current density of around 40 mA/cm2 to 60 mA/cm2 is applied or a corresponding current flows. In a period from 30 mins to 60 mins, an anodized layer then grows as a hard anodized layer on the carrier 213, in this case on the inside and outside, or wherever the carrier 213 is immersed into the galvanic bath 25. This galvanization process is known and can be easily implemented. By suitable masking of at least part of the surface of the carrier 213, growth of an anodized layer there can be prevented.

FIG. 4 shows an alternative method for applying an additional insulation layer to a rectangular carrier 13 according to FIG. 1 and/or to its hard anodized layer or normal anodized layer by means of thermal spraying. A plasma spraying device 33 is provided that applies aluminum oxide as plasma 35 in known manner to the heating conductor side 14. To do so, the plasma spraying device 33 can be moved accordingly over the carrier 13, or alternatively the carrier 13 can be moved relative to the plasma spraying device 33. The aluminum oxide of the plasma 35 hitting the heating conductor side 14 grows there as an additional insulation layer.

FIG. 5 shows how a sol-gel sealant 38 is sprayed by means of a spraying device 37 onto an anodized layer 116, corresponding to the heating device 111 of FIG. 2b. It forms a previously described thickening layer 119 on the anodized layer 16. It can fill possible pores or cracks in the anodized layer 116 and hence effect a dependable electrical insulation of the electrically conductive aluminum carrier 113. Furthermore, it forms in simple manner an additional electrically insulating layer and thus additionally improves the electrical insulation of the aluminum carrier 113, in particular against the heating conductor 121.

1. A method for manufacturing a heating device, wherein said heating device has a carrier and at least one heating conductor applied to said carrier, wherein said method has the steps:
provision of a carrier having a heating conductor side, wherein said carrier consists of aluminum,
generation of an anodized layer on said heating conductor side, wherein said anodized layer is generated directly on said carrier and/or said heating conductor side,
application of said at least one heating conductor above or onto said anodized layer.

2. The method according to claim 1, wherein an additional insulation layer is applied to said anodized layer.

3. The method according to claim 2, wherein said additional insulation layer is generated and applied by thermal spraying as an aluminum oxide layer.

4. The method according to claim 1, wherein said anodized layer is generated and applied in a galvanic method and to do so said carrier is moved at least with said heating conductor side into a galvanic bath, wherein said galvanic bath has an acid electrolyte, wherein said acid electrolyte has a temperature of less than 20° C.

5. The method according to claim 4, wherein said anodized layer is generated as a hard anodized layer by means of a relatively high current density.

6. The method according to claim 5, wherein said current density is greater than 20 mA/cm² or greater than 30 mA/cm².

7. The method according to claim 4, wherein said temperature of said galvanic bath is between 0° C. and 15° C.

8. The method according to claim 1, wherein said anodized layer is applied with a thickness between 20 μm and 150 μm.

9. The method according to claim 1, wherein said carrier consists of an aluminum alloy Al 99.5 or AlMg₃.

10. The method according to claim 1, wherein a thickening layer is applied to said anodized layer as a high-temperature-resistant thickening layer, wherein said heating conductors are applied directly onto said thickening laver.

11. The method according to claim 2, wherein a thickening layer is applied to said additional insulation layer as a high-temperature-resistant thickening layer, wherein said heating conductors are applied directly onto said thickening layer.

12. The method according to claim 10, wherein said thickening layer has a thickness between 10 μm and 100 μm.

13. The method according to claim 1, wherein said at least one heating conductor is applied above said anodized layer in a thin-film method or in a thick-film method.

14. A heating device with a carrier and at least one heating conductor applied thereto that has been manufactured with a method according to claim 1, wherein said heating device has:
said carrier with a heating conductor side, wherein said carrier consists of aluminum,
an anodized layer on said heating conductor side, wherein said anodized layer is generated directly on said carrier or onto said heating conductor side,
at least one said heating conductor above said anodized layer.

15. The heating device according to claim 14, wherein an additional insulation layer is applied to said anodized layer.

16. The heating device according to claim 15, wherein said additional insulation layer is applied directly onto said anodized layer.

17. The heating device according to claim 15, wherein said additional insulation layer is generated and applied by thermal spraying as an aluminum oxide layer.

18. The heating device according to claim 14, wherein said carrier consists of an aluminum alloy Al 99.5 or of AlMg₃.

19. The heating device according to claim 14, wherein a thickening layer is applied to said anodized layer as a high-temperature-resistant thickening layer.

20. The heating device according to claim 15, wherein a thickening layer is applied to said additional insulation layer.

21. The heating device according to claim 19, wherein said heating conductors are applied directly to said thickening layer.

22. The heating device according to claim 19, wherein said thickening layer has a thickness between 10 μm and 100 μm.
